(19) United States
(12) Patent Application Publication
(10) Pub. No.: US 2013/0286219 A1
(43) Pub. Date: Oct. 31, 2013

(54) Image Calibration System and Image Calibration Method Thereof

(71) Applicants: Ching-Sung Yeh, Changhua City (TW); Chung-Fang Chien, Taipei City (TW)

(72) Inventors: Ching-Sung Yeh, Changhua City (TW); Chung-Fang Chien, Taipei City (TW)

(73) Assignee: ALTEK AUTOTRONICS CORP., Hsinchu (TW)

(21) Appl. No.: 13/491,920

(22) Filed: Jun. 8, 2012

(30) Foreign Application Priority Data
Apr. 27, 2012 (TW) 101115270

(51) Int. Cl. H04N 17/06

(52) U.S. Cl. 348/187; 348/E17.002

(57) ABSTRACT

An image calibration system and an image calibration method thereof. The image calibration system includes an image capture module capturing a calibration image, first and second calibration tools comprising first and second calibration graphs respectively and a processing module calculating first and second calibration templates in the calibration image based on the first and second calibration graphs, and comparing the calibration image and the first and second calibration templates so as to obtain at least one locating point.

### CROSS-REFERENCE TO RELATED APPLICATION

This application claims the benefit of Taiwan Patent Application No. 101115270, filed on Apr. 27, 2012, in the Taiwan Intellectual Property Office, the disclosure of which is incorporated herein in its entirety by reference.

### BACKGROUND OF THE DISCLOSURE

1. Field of the Disclosure

The present invention relates to an image calibration system and image calibration method thereof, and more particularly, to an image calibration system and image calibration method thereof capable of automatically finishing image calibration, and thus with regards to assembly, reduction of working hours and enhancement of yields can be achieved.

2. Brief Description of the Related Art

Typically, before an image system of vehicle detects ground objects in an image and determines relative positions of objects, a corresponding relationship between coordinate positions in the image and world coordinate positions of roads should be established in advance. The process of establishing the corresponding relationship is called calibration.

First, the image system of vehicle determines positions of locating points on a calibration graph in an image. As shown in FIG. 1 of prior art, the calibration graph is arranged on the ground and the locating points are marked black points. Position of each locating point in the image can be calculated by using a point search technology. Alternatively, in the calibration graph, multiple grids are formed from multiple lines, and then cross points of the lines can be determined using a point search technology, acting as locating points. However, the calibration graph set on the ground is subject to being worn out by people or cars and caused to have black points or blurred lines. This leads the calibration graph to be difficult to be identified. An angle between the calibration graph set on the ground and an image capture lens causes captured images to have significant deformation. This leads an automatic point search technology to have relatively complicated and difficult algorithms.

Accordingly, in order to overcome problems of finding locating points, some technologies propose the calibration graph to be arranged in front of a car, but the calibration graph only covers a central region in front of the car and large errors occur at two sides of the image where the calibration graph at center region is used to estimate distances of objects. Furthermore, with regards to a place to produce cars, the calibration graph blocks a production flow.

Besides, an image calibration system encompasses an important part of analyzing the calibration graph, and a way to find the calibration graph in an image is also a key technology. Generally, the locating points are estimated using sides and corners of the calibration graph. However, the image not only contains the calibration graph but contains complicated backgrounds. This situation affects accuracy of searching point within the calibration graph. Thus, the backgrounds of the calibration graph are required to be a pure wall, and thus arrangement of a calibration place is constrained. If the whole of the image is compared with the calibration graph, a large amount of calculation would be created and led with prolonged calculation time.

Accordingly, what is needed is to design an image calibration system and an image calibration method thereof having an automatic, stable and soon finished image calibration process. Thereby, reduction of working hours and enhancement of yields can be achieved.

### SUMMARY OF THE DISCLOSURE

In order to improve the above-mentioned problems of prior art, the present invention is directed to an image calibration system and an image calibration method thereof improving accuracy of image calibration for car, reducing working processes and manpower and enhancing yields.

In accordance with an objective of the present invention, an image calibration system is suitable for calibrating a calibration image captured by an image capture module and is proposed including a first calibration tool and a second calibration tool comprising a first calibration tool and a second calibration graph respectively, a mobile carrier comprising the image capture module, wherein the first calibration tool and the second calibration tool are arranged at two sides of a path, along which the mobile carrier moves, and a processing module connecting with the image capture module, calculating a first calibration template and a second calibration template in the calibration image based on the first calibration graph and the second calibration graph, and comparing the calibration image with the first calibration template and second calibration template to obtain at least one locating point in the calibration image, wherein the locating point meets a position of the first calibration graph and the second calibration graph, wherein the first calibration tool is separate from the second calibration tool by a distance, wherein the first and second calibration graphs are arranged on surfaces of the first calibration tool and the second calibration tool respectively.

In an embodiment, the processing module scales down the calibration image, the first calibration template and the second calibration template in equal proportion to match the position of the first calibration graph and the second calibration graph by comparison.

In an embodiment, the processing module compares the calibration image and the first calibration template and the second calibration template to obtain a position of at least the locating point.

In an embodiment, the processing module calculates a predetermined position of the first calibration template and the second calibration template in the calibration image, determines a search area based on the predetermined position, scales down the calibration image, and compares and searches positions of the first calibration template and the second calibration template in the search area of the calibration image, and analyzes the position of the locating point in the search area based on the calibration image of original proportion.

In an embodiment, the processing module compares the scale-down first calibration template and the scale-down second calibration template with the scale-down calibration image to obtain a rough position, next chooses a small extent on the calibration image of original proportion to compare the calibration image with the first calibration template and the second calibration template based on the rough position to obtain the locating point in the calibration image, wherein the locating point meets the position of the first calibration graph and the second calibration graph.

In accordance with an objective of the present invention, an image calibration system is suitable for a calibration platform having a channel and a mobile carrier and is proposed including an image capture module capturing a calibration image, a first calibration tool and a second calibration tool comprising a first calibration graph and a second calibration graph respectively, wherein the first calibration tool is separate from the second calibration tool by a distance, wherein the first calibration graph and the second calibration graph are arranged on surfaces of the first calibration tool and the second calibration tool respectively; and a processing module calculating a first calibration template and a second calibration template in the calibration image based on the first calibration graph and the second calibration graph, and comparing the calibration image with the first calibration template and the second calibration template to obtain at least one locating point in the calibration image, wherein the locating point meets a position of the first calibration graph and the second calibration graph.

In an embodiment, the processing module scale down the calibration image and the first and second calibration templates in equal proportion so as to verify the position of the first and second calibration graphs by comparison.

In an embodiment, the processing module compares the calibration image with the first and second calibration templates so as to obtain a position of the at least one locating point.

In an embodiment, the processing module calculates a predetermined position of the first calibration template and the second calibration template in the calibration image, determines a search area based on the predetermined position, scales down the calibration image, and compares and searches positions of the first calibration template and the second calibration template in the search area of the calibration image, and analyzes the position of the locating point in the search area based on the calibration image of original proportion.

In an embodiment, the processing module compares the scale-down first calibration template and the scale-down second calibration template with the scale-down calibration image to obtain a rough position, next chooses a small extent on the calibration image of original proportion to compare the calibration image with the first calibration template and the second calibration template based on the rough position to obtain the locating point in the calibration image, wherein the locating point meets the position of the first calibration graph and the second calibration graph.

In accordance with an objective of the present invention, an image calibration method for an image calibration system is suitable for a calibration platform having a channel and a mobile carrier. The image calibration method includes the following steps: using an image capture module to capture a calibration image, wherein the image capture module is arranged on the mobile carrier; providing first and second calibration tools comprising first and second calibration graphs respectively; using a processing module to calculate first and second calibration templates in the calibration image based on the first and second calibration graphs; and using the processing module to compare the calibration image with the first and second calibration templates so as to obtain at least one locating point in the calibration image, wherein the locating point meets a position of the first and second calibration graphs.

In an embodiment, the image capture module is arranged on a car.

In an embodiment, the image capture module is arranged close to the ground at a central region in front of the mobile carrier.

Accordingly, in accordance with the present invention, the image calibration system and the image calibration method thereof have following advantages:

(1) The image calibration system and the image calibration method thereof improve accuracy of calculating and predicting positions of ground signs in front of a car.

(2) The image calibration system and the image calibration method thereof can detect lane markings or possible blocks from a car head to tens kilometers away from the car head and can enhance accuracy of calibration algorithms covering a front ground scope.

(3) The image calibration system and the image calibration method thereof can enhance stability of searching point within the calibration graphs and can be suitable for various calibration places.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

FIG. 1 is a schematic view of prior art.

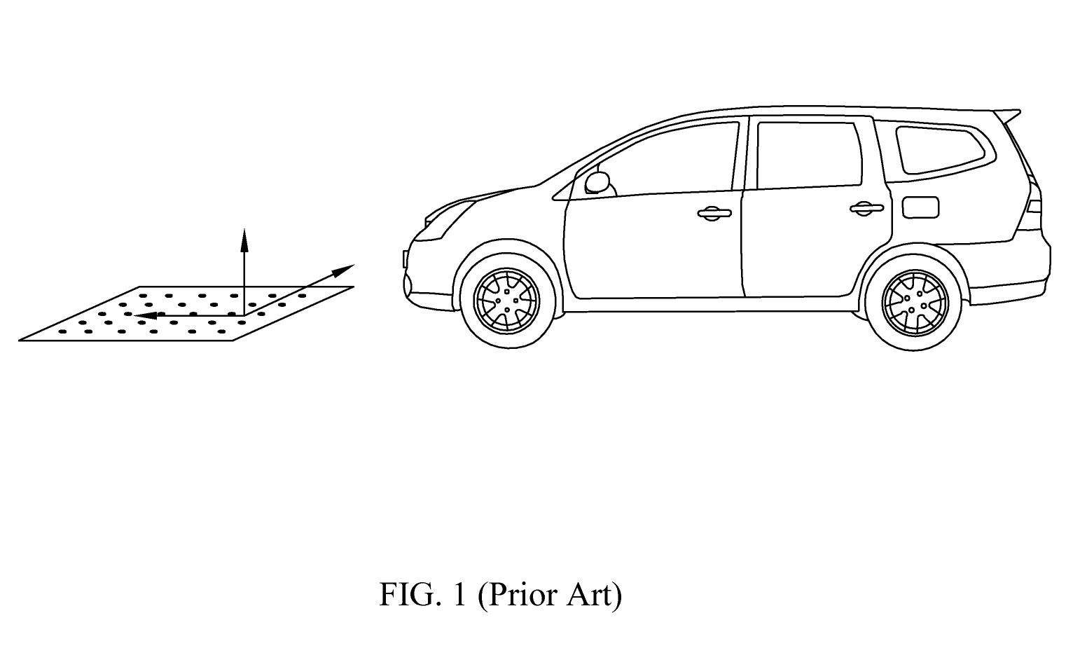

FIG. 2 is a first schematic view of an image calibration system in accordance with a first embodiment of the present invention.

FIG. 3 is a second schematic view of an image calibration system in accordance with a second embodiment of the present invention.

FIG. 4 is a schematic view of an image calibration system in accordance with a second embodiment of the present invention.

FIG. 5 is a flow chart of an image calibration method in accordance with a first embodiment of the present invention.

FIG. 6 is a flow chart of an image calibration method in accordance with a second embodiment of the present invention.

FIG. 7 is a flow chart of an image calibration method in accordance with a third embodiment of the present invention.

### DETAILED DESCRIPTION OF THE INVENTION

Following illustration accompanying with figures is embodiments for describing an image calibration system and an image calibration method thereof. In the following embodiments, same elements are indicated by same reference numbers.

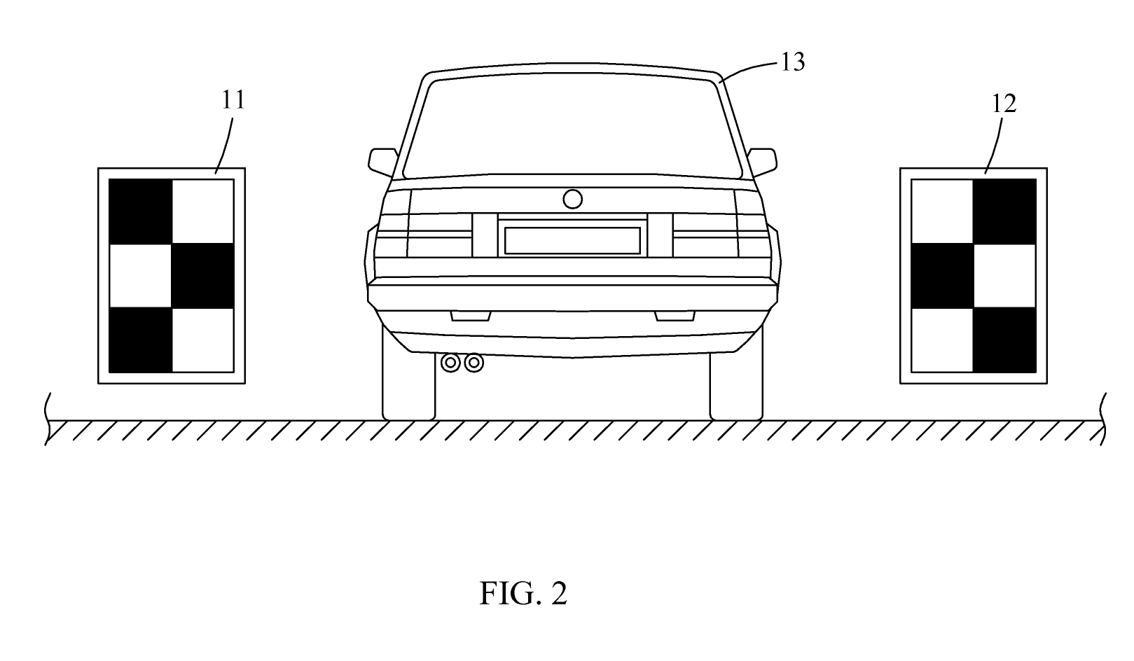

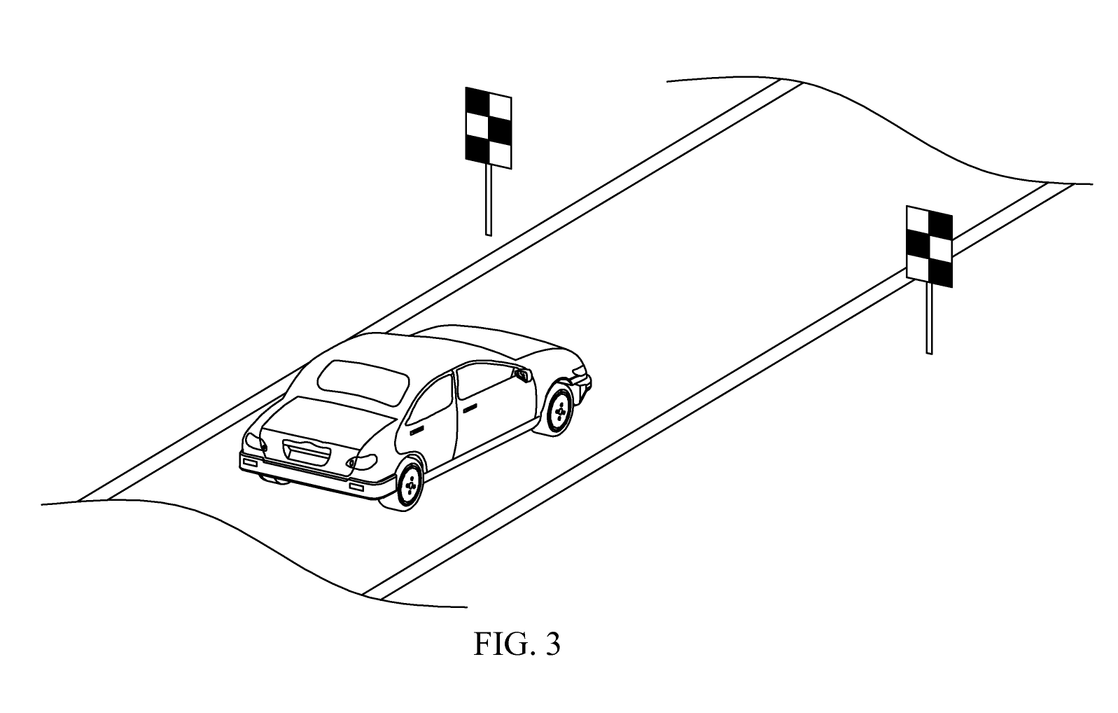

FIGS. 2 and 3 are first and second schematic views of an image calibration system in accordance with a first embodiment of the present invention. Referring to FIG. 2, an image calibration system is suitable for calibrating a calibration image captured by an image capture module. The image calibration system contains first and second calibration tools 11 and 12 comprising first and second calibration graphs respectively, a mobile carrier 13, such as a car in this embodiment, comprising an image capture module, wherein the first and second calibration tools 11 and 12 are arranged at two sides of a path, along which the mobile carrier 13 moves, and a processing module connecting with the image capture module, calculating first and second calibration templates in the calibration image based on the first and second calibration graphs, and comparing the calibration image with the first and second calibration templates so as to obtain at least one locating point in the calibration image, wherein the locating point meets a position of the first and second calibration graphs. The image capture module can be arranged close to the ground at a central region in front of the mobile carrier 13 or arranged close to the top of a car at a central region of a top side of a windshield. The image capture module includes a lens, an image sensor, such as complementary metal-oxide-semiconductor (CMOS) device or charge-coupled device (CCD), analog/digital circuits, an image processor and so on. The processing module can be a central processing unit (CPU) or a micro-processing unit.

Referring to FIG. 3, in this embodiment, the first and second calibration graphs are upright calibration graphs at left and right sides. When a car is parked in a calibration region, there are upright calibration graphs, composed of black and white grids, at left and right sides ahead in a specific distance. A relative distance between the first and second calibration graphs and a distance between the first or second calibration graph and the car head can be adjusted for production lines. Thereby, a calibration result can cover a relatively large scope of an image without excessively enlarged calibration graphs. The first and second calibration graphs may have patterns with 3*2 black and white grids and each may have a vertical dimension greater than a horizontal dimension thereof. Thereby, a distance between upper and lower locating points can be increased. In other words, lane markings or possible blocks from a car head to tens kilometers away from the car head can be detected and accuracy of calibration algorithms covering a front ground scope. The black and white grids have sizes that can be adjusted based on a relative distance between a calibration graph and a car. The above arrangement is an embodiment and should not be limited to the present invention.

A calibration graph, because composed of multiple grids, has obvious sides and corner. In order to enhance stability of searching point within the calibration graph, the processing module can calculate first and second calibration templates in the calibration image based on the first and second calibration graphs. In this embodiment, the calibration templates are at left and right sides, respectively and each have 3*2 grids. Next, the processing module calculates a predetermined position of the first and second calibration templates in the calibration image and determines a search area based on the predetermined position. Accordingly, the processing module can contract the calibration image, search, in the search area, and verify a position of the first and second calibration template in the calibration image by comparison, and analyze the position of the locating point in the search area based on the calibration image of original proportion.

Furthermore, the processing module compares the first and second contracted calibration templates with the contracted calibration image so as to obtain a rough position. However, a position searched using the contracted calibration image would have an error. For example, if the X-axis and Y-axis of the calibration image are contracted by ½, the whole of the calibration image has an error of 2 pixels. Next, the processing module compares to a small extent the calibration image of original proportion with the first and second calibration templates based on the rough position. Thereby, via the exactly comparing, the locating point in the calibration image can be obtained, wherein the locating point meets the position of the first and second calibration graphs.

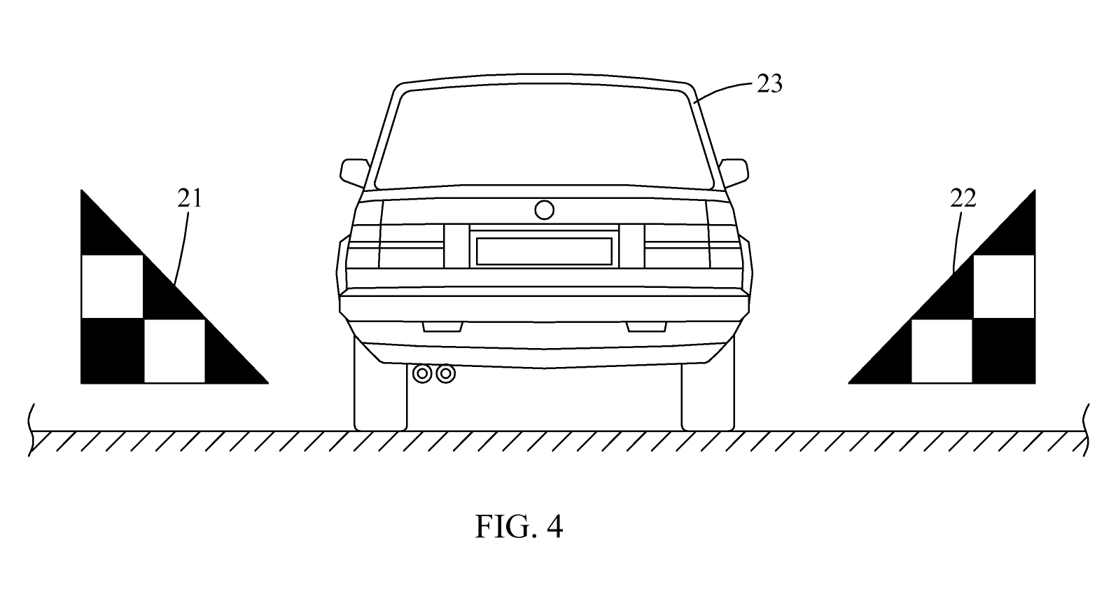

FIG. 4 is a schematic view of an image calibration system in accordance with a second embodiment of the present invention. Referring to FIG. 4, an image calibration system is suitable for calibrating a calibration image captured by an image capture module. The image calibration system contains first and second calibration tools 21 and 22 that can be upright triangle tools and includes first and second calibration graphs composed of black and white grids, wherein the first calibration tool 21 is separate from the second calibration tool 22 by a distance, wherein the first and second calibration graphs are arranged on surfaces of the first and second calibration tools 21 and 22, respectively, a mobile carrier 23, such as a car in this embodiment, and a processing module.

The processing module can calculate a shape of first and second calibration templates based on a design parameter and contract the calibration image and the first and second calibration templates in equal proportion so as to verify a position of the first and second calibration graphs by comparison. Finally, the processing module compares the calibration image and the first and second calibration templates so as to obtain at least a locating point in the calibration image, wherein the locating point meets the position of the first and second calibration graphs.

In the above explanation for the image calibration system, an image calibration method of the image calibration system is mentioned, but, for clarity, flow charts are further illustrated in following paragraphs.

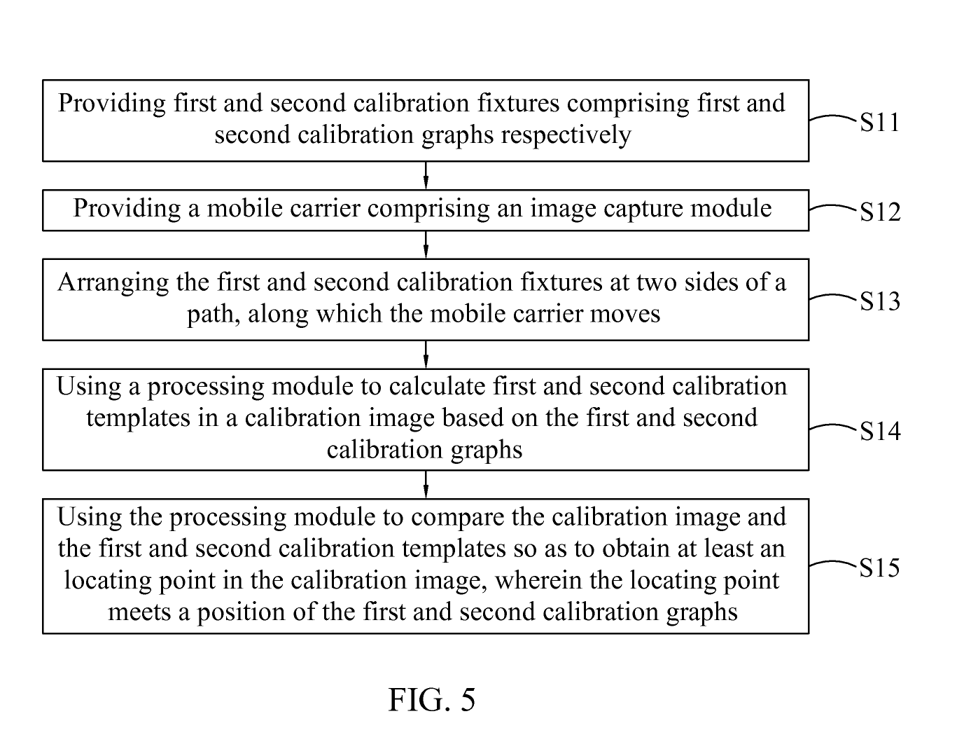

FIGS. 5-7 are flow charts of image calibration methods in accordance with first to three embodiments of the present invention. In accordance with the present invention, the image calibration methods are suitable for the above image calibration system, as mentioned above and omitted herein.

Referring to FIG. 5, the image calibration method of the image calibration system includes the following steps:

Step S11 includes providing first and second calibration tools comprising first and second calibration graphs respectively.

Step S12 includes providing a mobile carrier comprising an image capture module.

Step S13 includes arranging the first and second calibration tools at two sides of a path, along which the mobile carrier moves.

Step S14 includes using a processing module to calculate first and second calibration templates in a calibration image based on the first and second calibration graphs.

Step S15 includes using the processing module to compare the calibration image and the first and second calibration templates so as to obtain at least a locating point in the calibration image, wherein the locating point meets a position of the first and second calibration graphs.

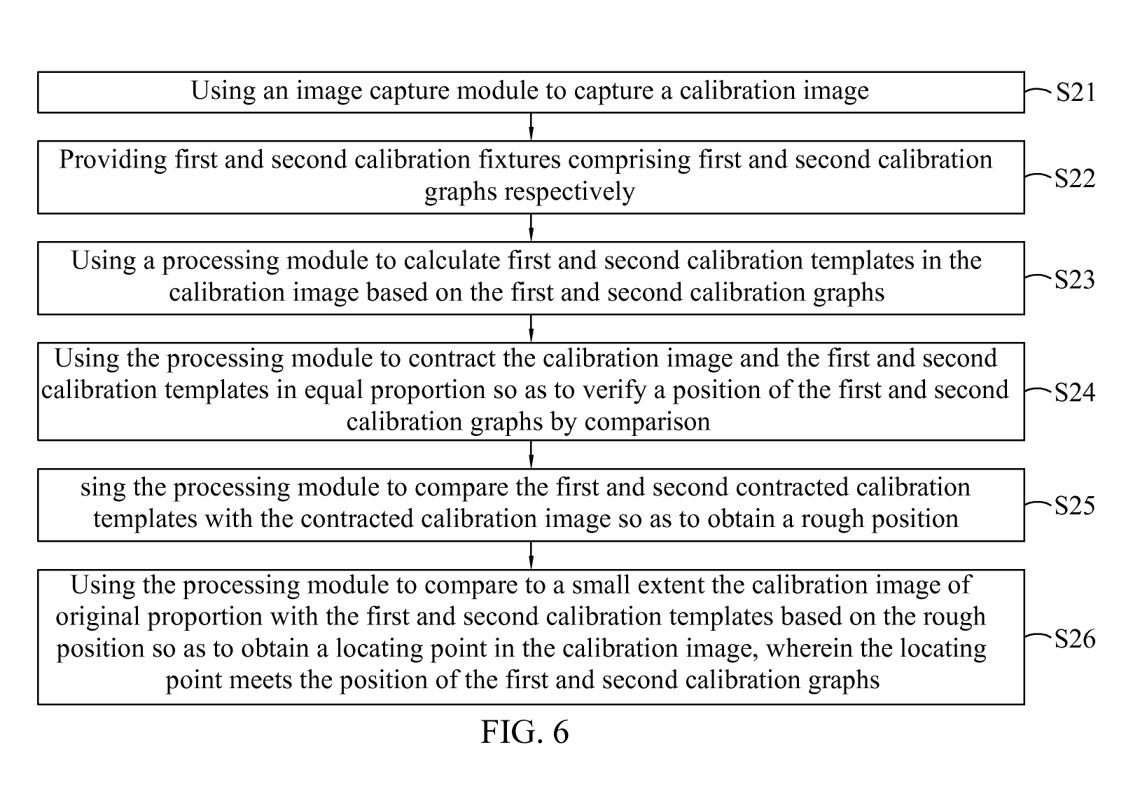

Next, referring to FIG. 6, the image calibration method of the image calibration system includes the following steps:

Step S21 includes using an image capture module to capture a calibration image.

Step S22 includes providing first and second calibration tools comprising first and second calibration graphs respectively.

Step S23 includes using a processing module to calculate first and second calibration templates in the calibration image based on the first and second calibration graphs.

Step S24 includes using the processing module to contract the calibration image and the first and second calibration templates in equal proportion so as to verify a position of the first and second calibration graphs by comparison.

Step S25 includes using the processing module to compare the first and second contracted calibration templates with the contracted calibration image so as to obtain a rough position.

Step S26 includes using the processing module to compare to a small extent the calibration image of original proportion with the first and second calibration templates based on the rough position so as to obtain a locating point in the calibration image, wherein the locating point meets the position of the first and second calibration graphs.

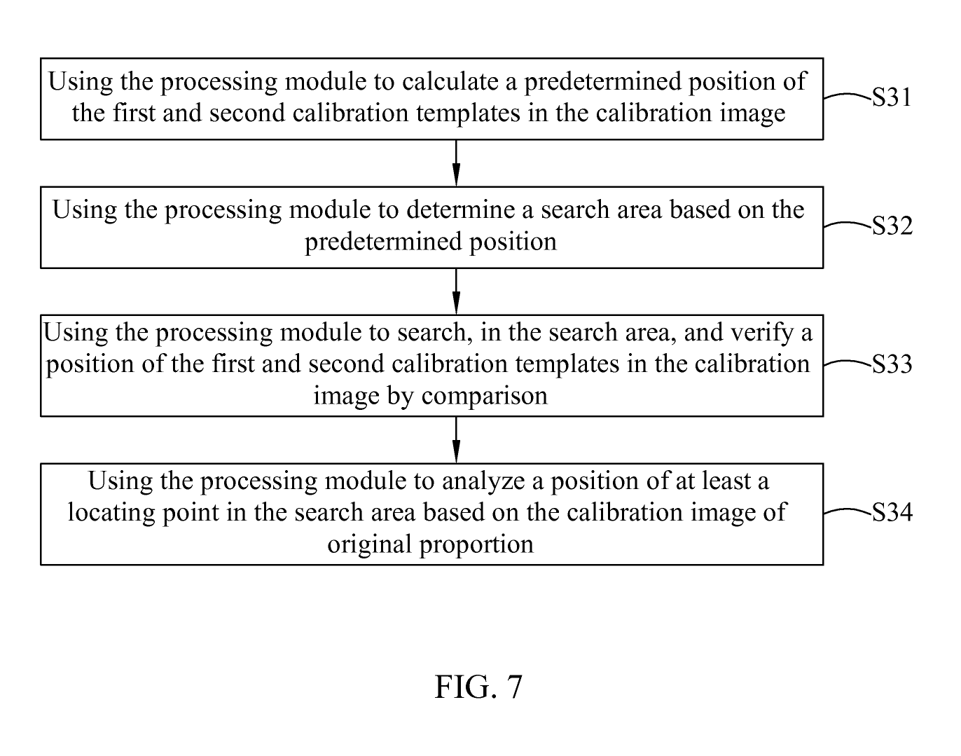

Next, referring to FIG. 7, the image calibration method of the image calibration system includes the following steps:

Step S31 includes using the processing module to calculate a predetermined position of the first and second calibration templates in the calibration image.

Step S32 includes using the processing module to determine a search area based on the predetermined position.

Step S33 includes using the processing module to search, in the search area, and verify a position of the first and second calibration templates in the calibration image by comparison.

Step S34 includes using the processing module to analyze a position of at least a locating point in the search area based on the calibration image of original proportion.

The image calibration system and the image calibration method of thereof are illustrated in the above paragraphs for explaining the image calibration system and omitted to be illustrated herein.

Illustrative embodiments accompanying with figures are above described but addition, modification or replacement applied to the embodiments of the present invention is within the scope of the claims. The skilled in the art would understand the invention can be realized with modification of multiple structures, arrangements, proportions and elements.

What is claimed is:

1. An image calibration system for calibrating a calibration image captured by an image capture module, comprising:
a first calibration tool and a second calibration tool comprising a first calibration graph and a second calibration graph respectively;
a mobile carrier comprising the image capture module, wherein the first calibration tool and the second calibration tool are arranged at two sides of a path, along which the mobile carrier moves; and
a processing module connected with the image capture module, calculating a first calibration template and a second calibration template in the calibration image based on the first calibration graph and the second calibration graph, and comparing the calibration image with the first calibration template and the second calibration template to obtain at least one locating point in the calibration image, wherein the locating point match positions of the first calibration graph and the second calibration graph;
wherein the first calibration tool is separate from the second calibration tool by a distance, and the first calibration graph and the second calibration graph are arranged on surfaces of the first calibration tool and the second calibration tool respectively.

2. The image calibration system of claim 1, wherein the processing module scales down the calibration image, the first calibration template and the second calibration template in equal proportion to match the positions of the first calibration graph and the second calibration graph by comparison and compares the calibration image with the first calibration template and the second calibration template to obtain the position of the at least one locating point.

3. The image calibration system of claim 2, wherein the processing module calculates a predetermined position of the first calibration template and the second calibration template in the calibration image, determines a search area based on the predetermined position, scales down the calibration image, and compares and searches positions of the first calibration template and the second calibration template in the search area of the calibration image, and analyzes the position of the locating point in the search area based on the calibration image of original proportion.

4. The image calibration system of claim 2, wherein the processing module compares the scale-down first calibration template and the scale-down second calibration template with the scale-down calibration image to obtain a rough position, next chooses a small extent on the calibration image of original proportion to compare the calibration image with the first calibration template and the second calibration template based on the rough position to obtain the locating point in the calibration image, wherein the locating point meets the position of the first calibration graph and the second calibration graph.

5. An image calibration system for a calibration platform having a channel and a mobile carrier, comprising:
an image capture module capturing a calibration image;
a first calibration tool and a second calibration tool comprising a first calibration graph and a second calibration graph respectively, wherein the first calibration tool is separate from the second calibration tool by a distance, wherein the first calibration graph and the second calibration graph are arranged on surfaces of the first calibration tool and the second calibration tool respectively; and
a processing module calculating a first calibration template and a second calibration template in the calibration image based on the first calibration graph and the second calibration graph, and comparing the calibration image with the first calibration template and the second calibration template to obtain at least one locating point in the calibration image, wherein the locating point meets a position of the first calibration graph and the second calibration graph.

6. The image calibration system of claim 5, wherein the processing module scale down the calibration image, the first calibration template and the second calibration template in equal proportion to match the position of the first calibration graph and the second calibration graph by comparison and compares the calibration image with the first calibration template and the second calibration template so as to obtain a position of the at least one locating point.

7. The image calibration system of claim 6, wherein the processing module calculates a predetermined position of the first calibration template and the second calibration template in the calibration image, determines a search area based on the predetermined position, scales down the calibration image, and compares and searches positions of the first calibration template and the second calibration template in the search area of the calibration image, and analyzes the position of the locating point in the search area based on the calibration image of original proportion.

8. The image calibration system of claim 6, wherein the processing module compares the scale-down first calibration template and the scale-down second calibration template with the scale-down calibration image to obtain a rough position, next chooses a small extent on the calibration image of original proportion to compare the calibration image with the first calibration template and the second calibration template based on the rough position to obtain the locating point in the calibration image, wherein the locating point meets the position of the first calibration graph and the second calibration graph.

9. An image calibration method for a calibration platform having a channel and a mobile carrier, comprising:
using an image capture module to capture a calibration image, wherein the image capture module is arranged on the mobile carrier;
providing a first calibration tool and a second calibration tool comprising a first calibration graph and a second calibration graph respectively;
using a processing module to calculate a first calibration template and a second calibration template in the calibration image based on the first calibration graph and the second calibration graph; and
using the processing module to compare the calibration image with the first calibration template and the second calibration template so as to obtain at least one locating point in the calibration image, wherein the locating point meets a position of the first calibration graph and the second calibration graph.

10. The image calibration method of claim 9, wherein the first calibration tool is separate from the second calibration tool by a distance, wherein the first calibration graph and the second calibration graph are arranged on surfaces of the first calibration tool and the second calibration tool respectively.

11. The image calibration method of claim 9, further comprising using the processing module to scale down the calibration image, the first calibration template and second calibration template in equal proportion so as to match a position of the first calibration graph and the second calibration graph.

12. The image calibration method of claim 11, further comprising using the processing module to compare the calibration image with the first calibration template and the second calibration template so as to obtain a position of the locating point.

13. The image calibration method of claim 11, further comprising:
using the processing module to calculate a predetermined position of the first calibration template and the second calibration template in the calibration image;
using the processing module to determine a search area based on the predetermined position;
using the processing module to scale down the calibration image;
using the processing module to compare and search positions of the first calibration template and the second calibration template in the search area of the calibration image; and
using the processing module to analyze a position of the locating point in the search area based on the calibration image of original proportion.

14. The image calibration method of claim 11, further comprising:
using the processing module to compare the scale-down first calibration template and the scale-down second scale-down calibration template with the calibration image so as to obtain a rough position; and
using the processing module to choose a small extent on the calibration image of original proportion to compare the calibration image with the first calibration template and the second calibration template based on the rough position so as to obtain the locating point in the calibration image, wherein the locating point meets the position of the first calibration graph and the second calibration graph.
